(19) United States
(12) Patent Application Publication
(10) Pub. No.: US 2013/0069375 A1
(43) Pub. Date: Mar. 21, 2013

(54) DOOR HOLDER

(71) Applicant: Mark Steven Jeffries, Buford, GA (US)

(72) Inventor: Mark Steven Jeffries, Buford, GA (US)

(73) Assignee: AUSTIN HARDWARE & SUPPLY, INC., Lee's Summit, MO (US)

(21) Appl. No.: 13/236,040

(22) Filed: Sep. 19, 2011

(51) Int. Cl. E05B 65/20; E05C 19/00; E05B 15/02

(52) U.S. Cl. 292/307 R; 292/340

(57) ABSTRACT

A door holder for holding open a door of an emergency or utility vehicle is described. The door holder includes a loop portion and a base portion. The loop portion is affixed or attached to an exterior surface of the door. The base portion is affixed or attached to a rear end wall of the ambulance. The base portion receives the loop portion in order to hold the door open. The loop portion and the base portion are adjustably positionable on the vehicle, which makes the installation of the door holder easier. Further, the adjustability of the door holder allows the operator to adjust the engagement of loop portion to the base portion.

### FIELD OF THE INVENTION

The present invention relates to a door holder for securing a door of an ambulance or other vehicle in a closed position.

### SUMMARY OF THE INVENTION

A door holder is herein described. The door holder may be used to secure a door of an ambulance or other vehicle in a closed position. The door holder includes a loop portion and a base portion. The loop portion is affixed or attached to an exterior surface of the door. The base portion is affixed or attached to a rear end wall of the ambulance. When an ambulance worker opens the door to the ambulance, the worker may insert the loop portion into the base portion in order to hold or maintain the door in the open position.

The door holder provides numerous advantages over existing door holders and door grabbers. The door holder is adjustable, which makes installation easier and more efficient. The base portion and/or the loop portion include slots that receive fasteners to attach the base portion and loop portion to the door or vehicle. The slots provide a range of adjustment for positioning the base portion and the loop portion on the door or vehicle. The slots also provide the ability to fine-tune the positions of the base portion and the loop portion to improve or modify the engaging/securing characteristics between the base portion and the loop portion.

The door holder further includes gaskets that provide a neater appearance and improved corrosion resistance. The gaskets include opening covers that fold over the base portion or the loop portion to cover the slots or other openings that receive the fasteners. The opening covers shield or hide the fasteners.

Further, the structure of the door holder provides improved strength and rigidity as compared to existing door holders and door grabbers. The loop portion receives threaded fasteners in a threaded internal diameter of legs of the loop portion. The threaded fasteners enter the legs generally parallel to a length of the legs.

Although the door holder is well suited for use with ambulances and other emergency vehicles, the door holder may be used with any of a variety of utility, cargo, rescue, fire, emergency, or other vehicles. Importantly, the door holder allows the worker to open the door and securely maintain the door in an open position in a single movement. As the door is moved to a fully open position, the loop portion inserts or removably attaches to the base portion and holds the door in the open position. This is helpful to the workers who need to quickly get the door open and maintain the door in an open position while the rear of the ambulance or other vehicle is accessed or entered. In order to close the door, the worker simply pulls on the door to release the loop portion from the base portion.

In one aspect, an adjustable door holder is described. The door holder includes a loop portion. The loop portion includes a loop having a first leg and a second leg attached or integral with a loop base. The loop base includes one or more slots to receive fasteners, and the fasteners are adjustably positionable in the slots. The door holder includes a base portion, which includes a catch. The catch receives the loop in order to hold the door open.

In another aspect, a door holder is described with a loop that fastens in a longitudinal manner to a loop base. The door holder includes a loop portion having the loop. The loop includes a first leg and a second leg attached or integral with the loop base. The first leg and the second leg define or form threaded internal diameters that are generally parallel to a longitudinal axis of the first leg and the second leg. Fasteners pass through the loop base and into the threaded internal diameters to secure the loop to the loop base. The door holder includes a base portion. The base portion includes a catch, and the catch receives the loop.

In another aspect, a door holder with an adjustable base is described. The door holder includes a loop portion, and the loop portion includes a loop having a first leg and a second leg attached or integral with a loop base. The door holder includes a base portion, and the base portion includes a catch. The catch receives the loop. The base portion further includes one or more slots to receive fasteners. The fasteners are adjustably positionable in the slots.

In another aspect, a door holder with a novel gasket is described. The door holder includes a loop portion, and the loop portion includes a loop having a first leg and a second leg attached or integral with a loop base. The loop base includes recesses, and the recesses define slots or openings to receive fasteners. The door holder includes a loop gasket having opening covers that cover or fold over the slots or the openings of the loop base. The door holder includes a base portion, and the base portion includes a catch. The catch receives the loop.

In another aspect, a door holder with multiple gaskets is described. The door holder includes a loop base having slots or openings. The door holder includes a loop having a first leg and a second leg attached or integral with the loop base. The door holder includes a loop gasket having openings. The loop gasket includes integral opening covers that cover or fold over the slots or the openings of the loop base. The door holder includes a catch. The door holder includes a base to hold the catch, and the base has slots or openings. The door holder includes a base gasket having openings, and the base gasket includes integral opening covers that cover or fold over the slots or the openings of the base.

### BRIEF DESCRIPTION OF DRAWINGS

FIG. 1 shows a rear view of the ambulance with the door holder installed.

FIG. 2 shows a view of the door moving to a closed position.

FIG. 3 shows a view of the door with the loop portion secured in the base portion.

FIG. 4 shows an exploded view of the door holder.

FIG. 5 shows a view of the door holder in an open position.

FIG. 6 shows a view of the door holder with the opening covers in an open position.

FIG. 7 shows a top down view of the door holder in the closed position.

FIG. 8 shows a side view of the base portion.

FIG. 9 shows a side view of the loop portion.

FIG. 10 shows a perspective view of the loop gasket.

FIG. 11 shows a top down view of the loop gasket.

FIG. 12 shows a side view of the loop gasket.

FIG. 13 shows a side view of the loop gasket with the opening covers in the open position.

FIG. 14 shows a perspective view of the base gasket.

FIG. 15 shows a top down view of the base gasket.

FIG. 16 shows a side view of the base gasket.

FIG. 17 shows a side view of the base gasket with the cover openings in the open position.

FIG. 18 shows a sectional view of the base portion.

FIG. 19 shows a sectional view of the loop portion.

FIG. 20 shows a sectional view of the loop portion.

FIG. 21 shows a sectional view of the loop portion with the lower portions riveted or malleated into the loop base.

FIG. 22 shows a sectional view of the loop portion with the lower portions staked into the loop base.

### DETAILED DESCRIPTION OF INVENTION

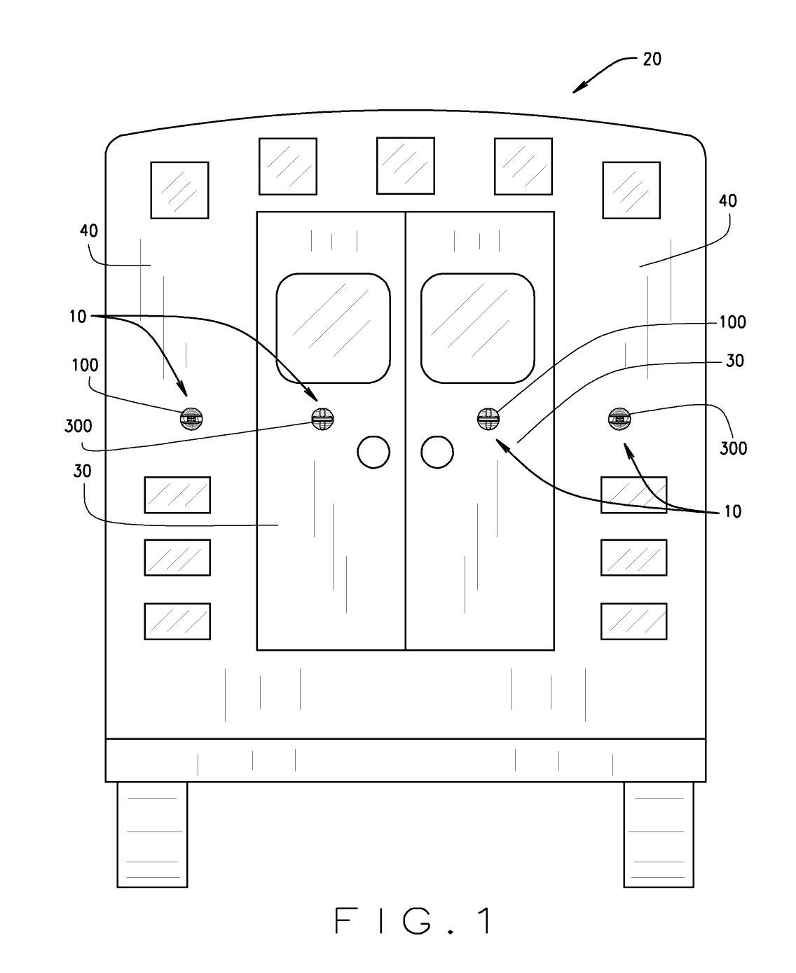

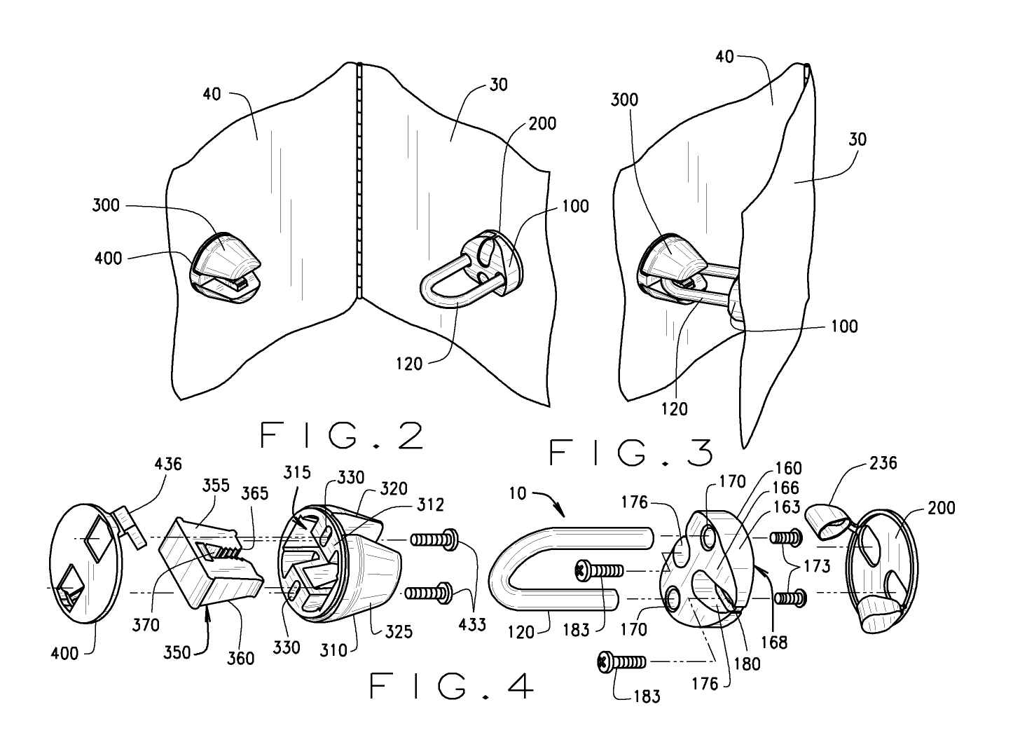

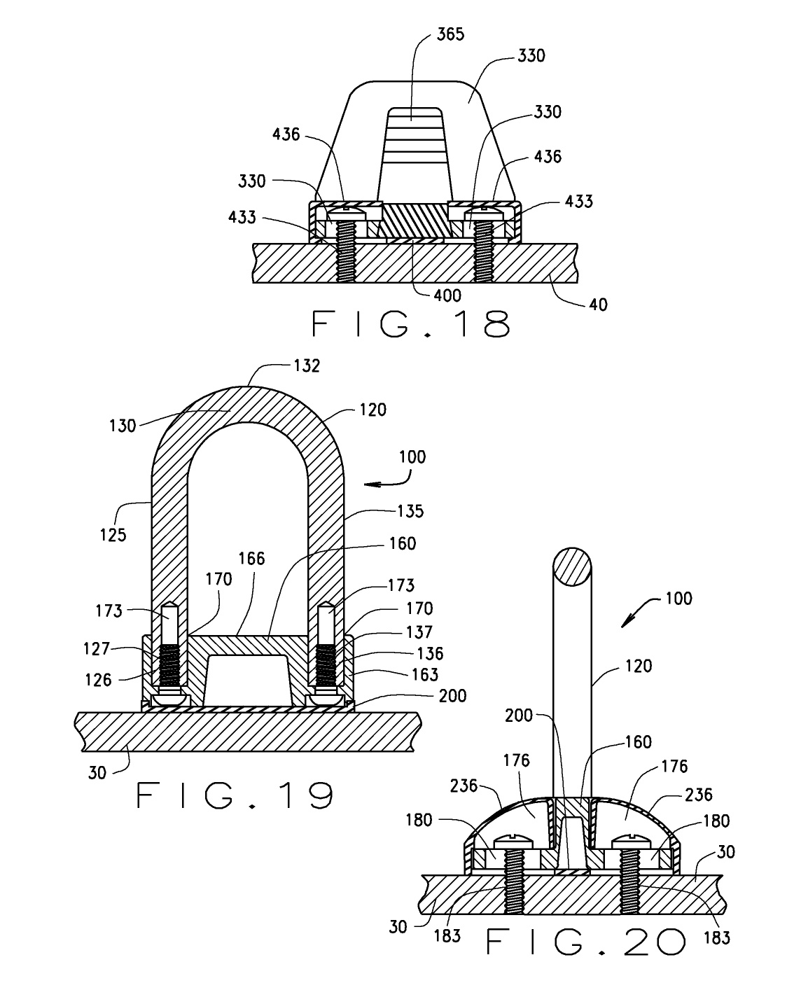

A door holder will now be described with reference to the FIGS. A door holder 10 is shown in FIGS. 1-22. In FIG. 1, the door holder 10 is shown installed on an ambulance 20. The door holder 10 includes a loop portion 100 that is installed on an exterior surface of a door 30 of the ambulance 20. The door holder 10 further includes a base portion 300 that is installed on a rear end wall 40 of the ambulance 20.

As the door 30 of the ambulance 20 swings to an open position, the loop portion 100 engages the base portion 300, and the base portion 300 holds the loop portion 100, thus holding the door 30 in the open position. Although the loop portion 100 is typically installed on the door 30 and the base portion 300 is typically installed on the rear end wall 40, the relative positions of the loop portion 100 and the base portion 300 may be reversed, i.e., to loop portion 100 may be installed on the rear end wall 40 and the base portion 300 may be installed on the door 30.

In operation, the worker swings open the door 30 in a conventional manner and urges the loop portion 100 into the base portion 300 to maintain the door 30 in an open position. The base portion 300 frictionally or flexibly holds the loop portion 100. This is useful when the ambulance 20 is parked on a hill or other incline and the doors 30 of the ambulance 20 are prone to or tend to swing to the closed position, which may be a hindrance or in the way of the worker. One or more door holders 10 may be used on the ambulance 20. The ambulance 20 of FIG. 1 shows the use of one door holder 10 on each of the doors 30.

The door holder 10 provides the ambulance worker or technician an efficient way to swing open the door 30 and quickly secure the door 30 in the open position. When it is time to close the door 30, the worker or technician simply pulls the door 30 and the loop portion 100 from the base portion 300 in a single movement that only requires one hand of the worker or technician.

The loop portion 100 will now be described with reference to FIGS. 4, 19, and 20. The loop portion 100 includes a loop 120 that attaches to or is integral with a loop base 160. The loop 120 includes a first leg 125 and a second leg 135. A middle portion 130 joins the first leg 125 and the second leg 135. The loop 120 fits into openings 170 of the loop base 160. Specifically, a lower portion 126 of the first leg 125 fits into the opening 170 of the loop base 160, and a lower portion 136 of the second leg 135 fits into the opening 170 of the loop base 160.

The lower portions 126 and 136 include threaded internal diameters 127 and 137. The openings 170 have a depth to receive all or a portion of the lower portions 126 and 136 to provide stability and structural integrity to the loop 120. Fasteners 173 pass through the loop base 160 and engage to the threaded internal diameters 127 and 137. As such, the loop 120 may be screwed or otherwise affixed to the loop base 160. The fasteners 173 are generally parallel to the longitudinal axis or length of the first leg 125 and the second leg 135. This promotes strength and structural integrity.

The loop base 160 includes sides 163 that lead into an outer surface 166. The openings 170 are in the outer surface 166 and form the depth into the loop base 160. The loop base 160 further includes recesses 176 to provide attachment to the door 30. The recesses 176 include or define slots or openings 180. Fasteners 183 pass from the exterior of the loop base 160 through the slots 180 and into the door 30 of the ambulance 20.

The shape of the slots 180 provides adjustability for positioning the loop base 160 on the door 30 of the ambulance 20. The fasteners 183 may be loosened or not fully tightened to allow the loop base 160 to move relative to the door 30 in order to properly position the loop base 160. With the fasteners 183 loosened or not fully tightened, the length of the slots 180 slide on the fasteners 183. The length of the slots 180 provide a range of varying positions for the loop base 160 to be fastened to the door 30.

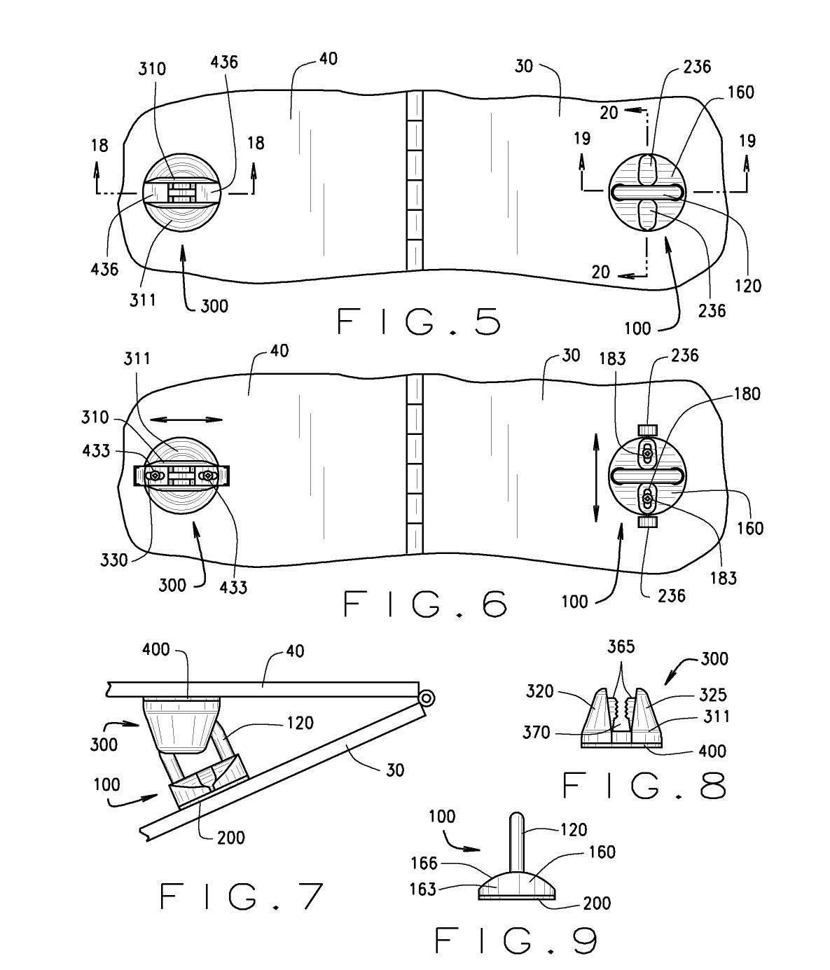

When the loop base 160 is in the correct position, the fasteners 183 are fully tightened to hold the loop base 160 on the door 30. As shown in FIG. 6, the loop base 160 may be moved in a vertical manner, i.e. up and down, on the door 30 of the ambulance 20. This provides adjustability and an easier installation for the technician when affixing or integrating the loop portion 100 on the door 30. The adjustability increases the installation tolerances and reduces the likelihood of having to reattach the loop base 160 to the door 30 in order to meet up with the base portion 300 on the rear end wall 40. The loop base 160 may similarly be moved up and down the length of the slots 180. The distance of the slots 180 provides enough adjustability to the loop base 160 to ease installation tolerances and reduce the need to re-drill pilot holes in the ambulance door 30 in situations where the loop base 160 was improperly installed.

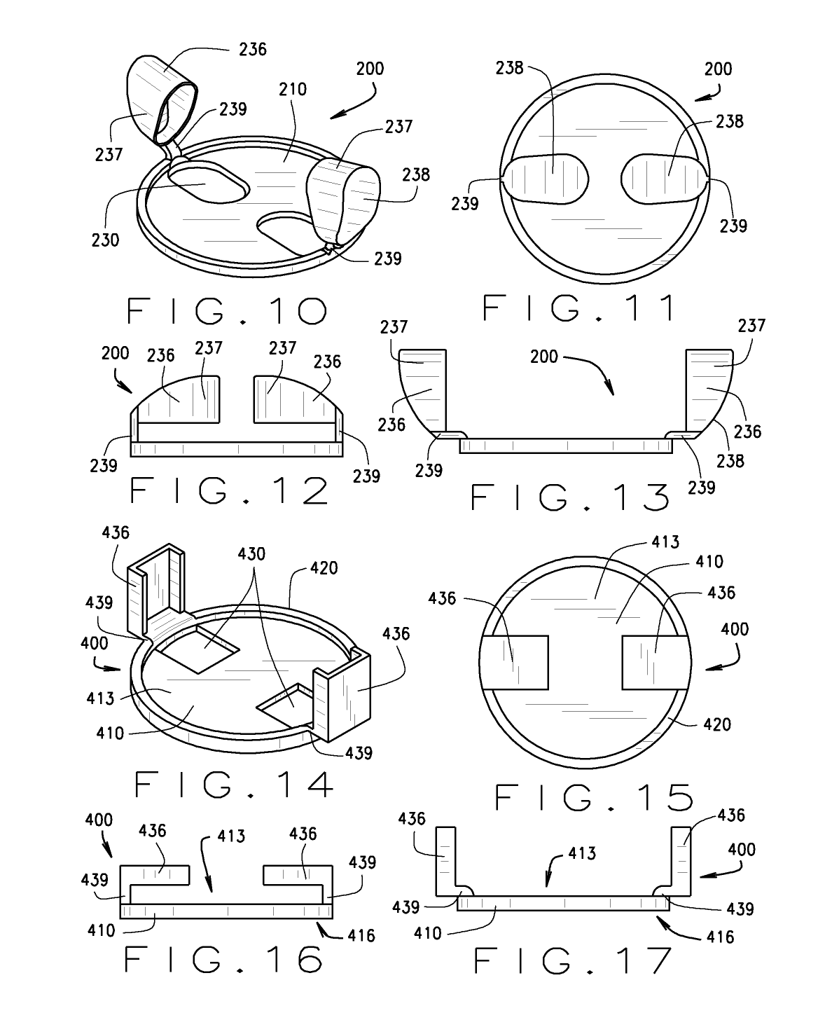

A loop gasket 200 is shown in FIGS. 10-13. The loop gasket 200 is positioned between the loop base 160 and the door 30. The loop gasket 200 includes a central portion 210 with a front surface 213 and a back surface 216. The front surface 213 receives a rear 168 of the loop base 160, while the back surface 216 is urged against the door 30 during the installation of the loop portion 100. The loop gasket 200 further includes a rim 220 around its periphery to align with the outer periphery of the loop base 160. The loop gasket 200 further includes openings 230 that allow the fasteners 183 that are passing through the slots 180 to pass through the loop gasket 200 and to enter or affix to the door 30.

The loop gasket 200 includes opening covers 236 that cover or fold over the recesses 176 and/or slots 180. The opening covers 236 may substantially fill the recesses 176. The opening covers 236 may be integral to the loop gasket 200 via a hinge portion 239. The opening covers 236 include sidewalls 237 that lead into an outer surface 238. The combination of the sidewalls 237 and the outer surface 238 provides a geometry, configuration or shape that approximates the outer surface 166 of the loop base 166. When the opening covers 236 fold over to cover the openings 230, the appearance of the loop base 160 is provided with a generally uniform appearance. The opening covers 236 further reduce corrosion by reducing the likelihood of moisture or water from entering into the recesses 176 and contacting the fasteners 183.

The base portion 300 will now be described with reference to FIGS. 4 and 8. The base portion 300 includes a base 310 that receives a catch 350. The base 310 includes an interior 315, a first side 320, and a second side 325. The interior 315 leads into an interior of the first side 320 and an interior of the second side 325.

The base 310 includes a front surface 311. The base 310 further includes slots 330 in wells 332 of the front surface 311 that allow fasteners 433 to pass through the base portion 300. The base 310 positions the catch 350 in order for the catch 350 to receive the loop 120 of the loop portion 100. The catch 350 may be made of a flexible or deformable material that flexes or expands to hold and receive the loop 120. The catch 350 may include opposing members that flexibility or frictionally hold the loop 120. In the aspect shown in FIG. 4, the catch 350 includes a first side 355 and a second side 360 that are oppositely disposed. Both the first side 355 and the second side 360 include a ribbed surface 365 on either side of a central opening 370. When the loop base 160 is engaged to the base 310, the first side 355 and the second side 360 expand to resiliently receive the loop 120, and the central opening 370 receives the middle portion 130 of the loop 120. The loop 120 is now held by the catch 350 of the base portion 300 with sufficient force to maintain or hold the door 30 in an open position under most conditions.

As shown in FIG. 6, the slots 330 provide the base portion 300 with the ability for horizontal adjustment, i.e., left and right adjustment, on the rear end wall 40 of the ambulance 20. Similar to the adjustability of the loop portion 100, the base portion 300 may be moved horizontally in order to ease the installation process of the base portion 300. The fasteners 433 may be loosened or not fully tightened to allow the base portion 300 to move relative to the rear end wall 40 as the length of the slots 330 slide on the fasteners 433. With the fasteners 433 loosened or not fully tightened, the length of the slots 330 slide on the fasteners 433. The length of the slots 330 provides a range of varying positions for the base portion 300 to be fastened to the rear end wall 40. When base portion 300 is in the correct position, the fasteners 433 are fully tightened to hold the base portion 300 on the rear end wall 40.

As described above, the loop base 160 may be moved in a vertical manner, i.e. up and down, on the door 30 of the ambulance 20, and the base portion 300 may be moved in a horizontal manner, i.e., left and right, on the rear end wall 40 of the ambulance 20. This allows the operator to fine tune the positioning of the loop base 160 and the base portion 300 such that the loop 120 is directed toward a center of the catch 350 and into the central opening 370 of the catch 350. The operator may adjust the position of the loop base 160 and the base portion 300 so that the middle portion 130 of the loop 120 is approximately centered between the first side 355 and the second side 360 of the catch 350. This provides the proper and consistent holding of the loop base 160 by the base portion 300. If one or both of the loop base 160 and the base portion 300 are out of position, then the middle portion 130 may be forced more strongly against one of the first side 355 or the second side 360 of the catch 350, resulting in uneven holding and poor performance.

With reference to FIGS. 14-17, a base gasket 400 is shown. The base gasket 400 is positioned between the base portion 300 and the rear end wall 40 of the ambulance 20. The base gasket 400 includes a central portion 410 having a front surface 413 and a back surface 416. The back surface 416 is urged against the rear end wall 40 during the installation of the base portion 300. The front surface 413 receives a rear side 312 of the base 310. The base gasket 400 further includes a rim 420 around its periphery. The base gasket 400 includes openings 430 that provide for the fasteners 433 to pass through the base gasket 400.

The base gasket 400 further includes opening covers 436 that cover the slots 330 and/or wells 332. The opening covers 436 may substantially fill the wells 332. The opening covers 436 are connected via a hinge portion 439 to the base gasket 400. As shown in FIG. 5, the opening covers 436 provide a uniform and clean appearance to the base portion 300. Further, the opening covers 436 reduce corrosion by reducing the likelihood of water and moisture from contacting the fasteners 433. Similar to the opening covers 236, the opening covers 436 bend over the wells 332 to cover the wells 332 and the fasteners 433.

The loop gasket 200 and the base gasket 400 may be formed from an elastomeric material, such as a neoprene rubber. The base gasket 400 and the loop gasket 200 assist in sealing the loop portion 100 to the door 30 and the base portion 300 to the rear end wall 40.

The base portion 300 may be made from a zinc metal or other suitable metals or alloys. The loop 120 may be made from a stainless steel metal or other suitable metals or alloys.

The door holder 10 herein described provides a stronger and more durable door holder or door grabber as compared to existing designs. Workers and technicians often use the loop portions of such door holders or door grabbers as a step to reach the top of the ambulance or other utility vehicle. As such, it is important that the loop portion 100 is designed to withstand the weight of such individuals.

The adjustability of the loop portion 100 and the base portion 300 allows a greater ease of installation for the loop portion 100 and the base portion 300 to the ambulance 20. The loop portion 100 may be adjusted slightly vertically in order to better align with the base portion 300. Likewise, the base portion 300 may be adjusted horizontally to better align with the loop portion 100. In addition to making installation easier, the adjustability of both the loop portion 100 and the base portion 300 allow the operator to fine-tune the closing characteristics of the door holder 10, such that doors 30 on an individual ambulance 20 or the doors 30 in a fleet of ambulances 20 or other vehicles may all close with approximately the same closing force or pressure.

Although the ambulance 20 shows a door holder 10 on each of the doors 30, the ambulance 20 may include a single door holder 10 on only one of its doors 30. Further, in other aspects, the base portion 300 may be designed to adjust vertically, and the loop portion 100 may be designed to adjust horizontally.

The fasteners 183, 173, and 433 may be any of a variety of conventional screws, bolts, rivets, or other fastening hardware.

The loop 120 may have an overall length of approximately 2 inches to approximately 10 inches. The loop 120 may have a diameter of approximately ¼ inch to approximately 1 inch.

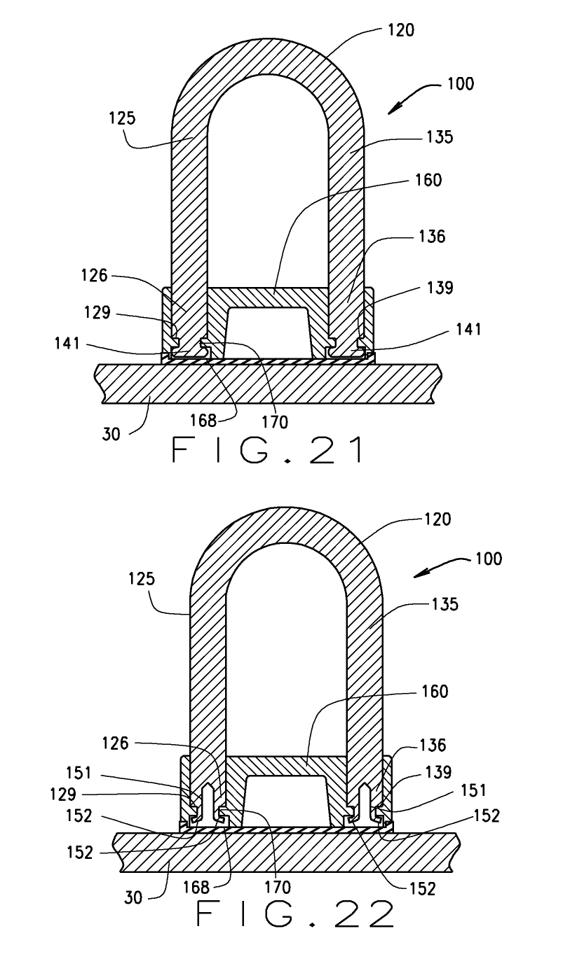

In other aspects, as shown in FIGS. 21 and 22, the lower portion 126 of the first leg 125 and the lower portion 136 of the second leg 135 transition into shoulder portions 129 and 139, respectively. The shoulder portions 129 and 139 may narrow in diameter compared to the lower portions 126 and 136. With reference to FIG. 21, the shoulder portions 129 and 139 transition into connection portions 141 that pass through the opening 170 of the loop base 160. The connection portions 141 may be orbitally riveted or malleated from the rear 168 of the loop base 160 to secure the loop portion 100 with the loop base 160. In other aspects, as shown in FIG. 22, the loop portion 100 may be staked to the loop base 160. The shoulder portions 129 and 139 transition into connection portions 151 that pass through the opening 170 of the loop base 160. Ends 152 of the connection portions 151 may be staked from the rear 168 of the loop base 160 to secure the loop portion 100 to the loop base 160.

It should be understood from the foregoing that, while particular embodiments of the invention have been illustrated and described, various modifications can be made thereto without departing from the spirit and scope of the present invention. Therefore, it is not intended that the invention be limited by the specification; instead, the scope of the present invention is intended to be limited only by the appended claims.

What is claimed is:

1. A door holder, comprising:
a loop portion, the loop portion comprising a loop having a first leg and a second leg attached or integral with a loop base;
the loop base comprising one or more slots to receive fasteners, and the fasteners are adjustably positionable in the slots; and,
a base portion, the base portion includes a catch, wherein the catch receives the loop.

2. The door holder according to claim 1, wherein the catch frictionally or flexibly holds the loop portion.

3. The door holder according to claim 1, wherein the loop portion is installed on a door of an ambulance, and the base portion is installed on a rear end wall of the ambulance.

4. The door holder according to claim 1, wherein a lower portion of the first leg fits into a first opening of the loop base, and a lower portion of the second leg fits into a second opening of the loop base.

5. The door holder according to claim 4, wherein the lower portions include threaded internal diameters, the openings have a depth to receive all or a portion of the lower portions, and additional fasteners pass through the loop base and engage to the threaded internal diameters.

6. The door holder according to claim 4, wherein the loop base includes recesses, and the recesses include or define slots, and the fasteners pass from the exterior of the loop base, through the slots, and into a door or a wall of a vehicle.

7. The door holder according to claim 6, wherein the slots provides adjustability for positioning the loop base on the door or the wall, and the loop base is movable in a vertical manner on the door or the wall.

8. The door holder according to claim 1, further comprising a loop gasket having openings that allow the fasteners that are passing through slots of the loop base to pass through the loop gasket and to enter or affix to a door or a wall, and the loop gasket includes opening covers that cover or fold over the slots.

9. The door holder according to claim 8, wherein the opening covers are integral to the loop gasket via a hinge portion.

10. The door holder according to claim 1, wherein the catch includes a first side and a second side that are oppositely disposed of a central opening.

11. The door holder according to claim 10, wherein the loop engages to the base portion, the first side and the second side expand to resiliently receive the loop, and the central opening receives a middle portion of the loop.

12. The door holder according to claim 1, wherein the loop is held by the catch of the base portion with sufficient force to maintain or hold a door in an open position.

13. The door holder according to claim 1, wherein the base comprises slots to provide the base portion with horizontal adjustment on a rear end wall or a door.

14. The door holder according to claim 1, further comprising a base gasket having opening covers that cover slots or openings of the base portion.

15. The door holder according to claim 14, wherein the opening covers are connected via a hinge portion to the base gasket.

16. The door holder according to claim 1, wherein a lower portion of the first leg fits into a first opening of the loop base, and a lower portion of the second leg fits into a second opening of the loop base, and the lower portions include connection portions that are orbitally riveted, malleated, or staked to secure the loop portion to the loop base.

17. A door holder, comprising:
a loop portion, the loop portion including a loop having a first leg and a second leg attached or integral with a loop base, wherein the first leg and the second leg define or form threaded internal diameters that are generally parallel to a longitudinal axis of the first leg and the second leg, wherein fasteners pass through the loop base and into the threaded internal diameters to secure the loop to the loop base; and,
a base portion, the base portion includes a catch, wherein the catch receives the loop.

18. A door holder, comprising:
a loop portion, the loop portion including a loop having a first leg and a second leg attached or integral with a loop base;
a base portion, the base portion comprising a catch, wherein the catch receives the loop; and,
the base portion further comprising one or more slots to receive fasteners, and the fasteners are adjustably positionable in the slots.

19. A door holder, comprising:
a loop portion, the loop portion including a loop having a first leg and a second leg attached or integral with a loop base;
the loop base includes recesses, the recesses define slots or openings to receive fasteners;
a loop gasket including opening covers that cover or fold over the slots or the openings of the loop base; and,
a base portion, the base portion includes a catch, wherein the catch receives the loop.

20. The door holder according to claim 19, further comprising a base gasket, wherein the base gasket comprising opening covers that cover or fold over slots or openings of the base portion.

21. A door holder, comprising:
a loop base having slots or openings;
a loop having a first leg and a second leg attached or integral with the loop base;
a loop gasket having openings, and the loop gasket including integral opening covers that cover or fold over the slots or the openings of the loop base;
a catch;
a base to hold the catch, the base having slots or openings; and
a base gasket having openings, and the base gasket including integral opening covers that cover or fold over the slots or the openings of the base.
